(19) United States
(12) Patent Application Publication
(10) Pub. No.: US 2011/0100960 A1
(43) Pub. Date: May 5, 2011

(54) ION SPECTROMETRIC MULTIPOLE ROD SYSTEMS MADE BY WIRE EROSION

(76) Inventor: Jens Rebettge, Schwanewede (DE)

(21) Appl. No.: 12/939,652

(22) Filed: Nov. 4, 2010

(30) Foreign Application Priority Data
Nov. 4, 2009 (DE) 10 2009 051 891.6

(51) Int. Cl. B23H 1/00

(52) U.S. Cl. 219/69.17; 219/69.11

(57) ABSTRACT

A method for fabricating a multipole system from a composite, comprising metal and insulating components rigidly fastened together, includes spark erosion cutting with a moving wire cathode to create a solid block whose metal pole faces are accurately parallel to one another.

### PRIORITY INFORMATION

This patent application claims priority from German Patent Application No. 10 2009 051 891.6 filed on Nov. 4, 2009, which is hereby incorporated by reference.

### FIELD OF INVENTION

The invention relates to a method for manufacturing precision multipole rod systems that can be supplied with RF voltages for use as ion guide systems with collision focusing, mass-selective quadrupole filters or cells for collision-induced fragmentation in mass or ion mobility spectrometers.

### BACKGROUND OF THE INVENTION

A variety of methods are known for the manufacture of multipole rod systems. Precisely honed round rods, fastened to suitably ground ceramic rings usually by screws, were often used for quadrupole rod systems intended for analytic use. This manufacturing method is difficult, and the resultant yield of successfully operating quadrupole filters has been unsatisfactory. Later, hyperbolically ground metal rods were used, screwed into precisely fabricated glass cages. The glass cages were manufactured using a hot replica process on an accurately ground core (KPG, from the German for “calibrated precision glass”). These hyperbolic quadrupole rod systems provided a significantly increased ion transmission, and are used successfully until recently, sometimes with accurately ground ceramic intermediate pieces instead of the glass cages.

U.S. Pat. No. 4,213,557 to J. Franzen et al discloses a manufacturing method wherein four elongated metal foils are fused as electrodes onto the inner surfaces of a glass body with a suitable hyperbolic shape during the hot replica phase of the KPG procedure. This method produces rigid, high-precision quadrupole rod systems which cannot be de-adjusted and are highly suitable for mass filters that can also be used under unfavorable environmental conditions, such as in vehicles. Their mass range is, however, restricted to about m/z=1000 Dalton because leakage currents can occur at higher RF voltages.

Thin round rods or capillaries were, for a long time, used for hexapole and octopole rod systems intended for use purely as ion guide systems to transport ions from one location to another. In order to allow the RF generators used to be small and inexpensive, by requiring only low voltages, the round rods or capillaries have diameters of only about 0.5 to 1.5 millimeters, usually about 0.8 millimeters, with internal separations of about 2 to 4 millimeters. They are fabricated from hard-drawn metal, usually stainless steel, and in some cases are externally gold plated. Tabs are spot-welded on for the purposes of attachment, and these were screwed to insulating rings equipped with voltage feeders. This method of manufacture was not highly reproducible, and the ion guide systems made in this way are extremely sensitive to impacts and to bending forces; they are also sensitive to mechanical or acoustic vibrations, which can cause them to resonate. In addition, they often tear off at the spot-welded attachment sites. The rods or capillaries supplied were not exactly straight and had to be repeatedly realigned, sometimes even after each processing stage. Slight deformations that result in irregular inside diameters can, however, significantly reduce the ion transmission or even entirely block it.

An improved method for the manufacture of multipole rod systems was developed a few years ago on the basis of wire erosion. See U.S. Pat. No. 7,351,963. It is particularly suitable for the manufacture of precision multipole rod systems, and results in much more stable ion guide systems. In this method, the metal multipole parts having two, three or even four pole rods which must be connected in common to the same phase of a two-phase RF voltage, are manufactured as a one-piece metal part in a single processing step by wire erosion from a single metal block turned by a lathe, the pole rods kept together by a remaining metal ring. The one-piece metal part contains all the longitudinal pole rod electrodes for one phase of the two-phase RF voltage. A pair of such a metal multipole parts, assembled facing each other with a single insulating ring, form the complete multipole system. See U.S. Pat. No. 7,351,963. The external mounting ring here must not be arranged centrally in relation to the length of the multipole system, but preferably must be displaced away from the center by half the thickness of an insulating ring.

In this method, the pole rods for precision ion guide systems with rod distances of only 2 to 4 millimeters can be significantly thicker toward the outside, but matching the vertex radius, as a result of which stability is improved. However, since the pole rods are only connected at one location to the outer metal ring, and this outer ring is joined via the insulating ring to the outer ring of the other multipole part, it is difficult to achieve precise assembly with accurately parallel alignment of all the pole faces to one another, and this cannot always be guaranteed.

There is a need for an improved manufacturing method, and in particular for larger, longer multipole systems intended for use as ion guides, quadrupole filters or collision cells.

### SUMMARY OF THE INVENTION

A basic idea of the invention is to first fasten together oversized metal parts for the multipole rod system and appropriate insulating rings, to form an inseparable block, for instance by adhesive bonding, soldering, brazing or riveting, and then to cut out the precise contours of the pole rods by wire erosion. Individual oversized metal rods may be brazed to metalized, glass-ceramic rings, before utilizing wire erosion to create the inner surfaces of the pole rods with high precision and closely parallel to each other. It is also possible to glue a single metal block with precise external dimensions into insulating rings and then cut the pole rods from the single metal block.

By attaching two insulating rings close to the ends of the pole rods, not only an inherently stable arrangement will be achieved, but precise fitting into the surrounding mechanical holding systems is also ensured. The multipole arrangement is attached to the holding system, for instance by enclosing in a mounting tube. As a result widely separated insulating rings here largely avoid any tilting. It is also possible to employ more than two insulating rings. Furthermore, the rings may have a polygonal outer contour, with plane surfaces which can easily be fastened to surfaces of holding structures.

Instead of the two insulating rings, a long insulating tube may be used, enveloping the rod system. Such a tube requires that a certain gas pressure be maintained inside the multipole rod system. Such systems enclosed by ceramic or glass tubes may be used as collisional fragmentation cells, as ion reaction cells, or as ion guides with collisional focusing. The transport of ions through the multipole rod system may be performed by a controlled gas flow through the tube.

By appropriate selection of the coefficients of expansion of the insulating rings and the metal pole rods, it is possible to ensure that the diagonal distance between the rod remains relatively constant even when temperatures vary.

The contacts of the pole rods, and in particular the interconnection of those pole rods that are joined to one phase of the RF voltage, can easily be applied prior to the wire erosion, for instance through spot welding. Mechanical distortion stresses that may be present in the metal as a result of preparatory working processes such as sawing, turning, drilling or spot welding can largely be annealed out by heat treatment prior to joining the metal to the insulators, so that the metal is not distorted through the relief of stress in the course of wire erosion. The wire erosion, which may take place in de-ionized water without creating additional mechanical or thermal stresses, does not introduce additional distortion stresses, in sharp contrast to machining by turning, milling or grinding. Residual mechanical distortion stresses can be relieved through a first, approximate wire erosion pass, known as roughing, prior to a second pass, the precision pass, that machines the final contours into the now relaxed metal.

Wire erosion, which is a modification of spark erosion, has now been developed into a highly precise method. It can be used to fabricate precise and smooth surfaces, particularly when these surfaces need to be parallel. The roughness is between about 0.05 and 0.5 micrometers. The dimensional accuracy of the surfaces lies in the range of about three micrometers, sometimes much closer, and can still be improved. The metal components can be manufactured from aluminum, stainless steel, brass or many other materials; aluminum is particularly easy to process. The inner surfaces of the multipole electrodes that face the axis can be given cylindrical or hyperbolic form through appropriate programming of the erosion machine.

The insulating rings or tubes can be made of glass, glass-ceramic (e.g., MACOR® machinable glass ceramic available from Corning), ceramic, plastic or even of metal with insulating layers of sufficient strength against disruptive electric discharges. Components or layers with a low tendency to shrink can be made from plastics with mineral fillers.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 illustrates a prior art hexapole part, whose three pole rods 4 for one of the two RF phases with their connecting ring 2 have been manufactured as a single piece from a single turned part by wire erosion.

FIG. 2 reproduces an perspective view of the prior art assembled hexapole rod system consisting of two hexapole single-piece parts as shown in FIG. 1 and an insulating ring 5. The assembly process is critical, as it requires a highly precise alignment.

FIGS. 3a, 3b and 3c show examples of the steps according to an aspect of the present invention. FIG. 3a shows a metal main body 20 having turned stop edges 21 for the insulating rings, and four milled grooves 22. FIG. 3b shows how the insulating rings 23 are attached; the mating faces 24 are used for adhesive bonding, soldering or brazing. FIG. 3c illustrates quadrupole rod system cut out from the solid block shown in FIG. 3b by wire erosion, creating a composite part.

FIG. 4 shows perspective views of the items shown in FIGS. 3a to 3c.

FIGS. 5a, 5b and 5c illustrate the manufacture of a somewhat different structure of a quadrupole rod system. FIG. 5a shows an insulating ring 30, preferably manufactured from MACOR® machinable glass ceramic, with grooves 31 cut on the inside, where the grooves 31 separate the mating faces 32 from one another. FIG. 5b shows how a metal cylinder 34 is glued into the insulating ring. In FIG. 5c the finished quadrupole rod system that has been cut from the metal cylinder can be seen, here including screening shields 36 in addition to the pole rods 35. The screening shields 36 serve to define positively the potential between the pole rod gaps and to screen out interfering external potentials.

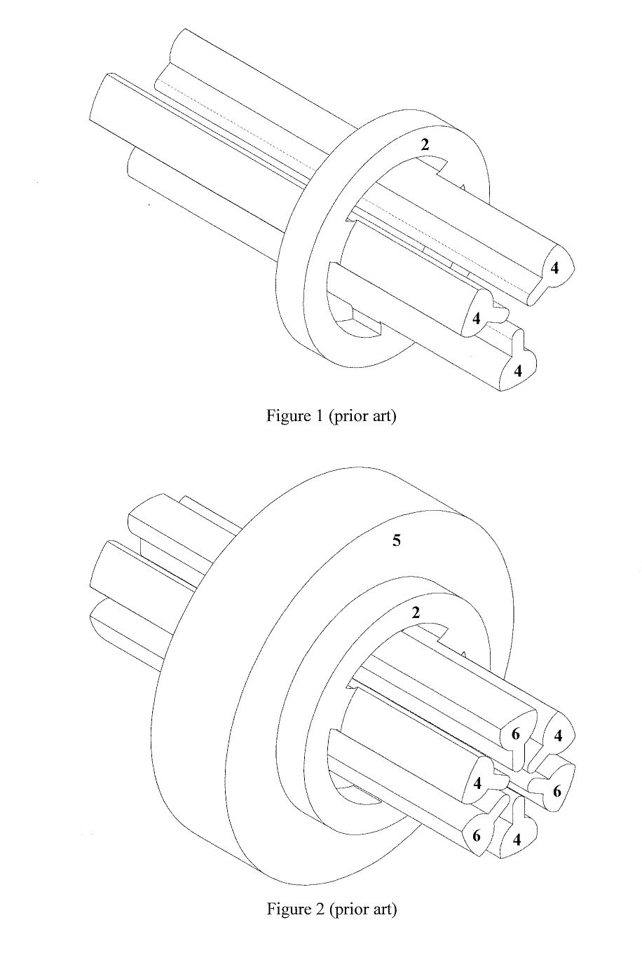

### DETAILED DESCRIPTION OF THE INVENTION

As described above, an aspect of the invention includes joining the metal parts for the multipole rod system and the matching insulating rings or tubes together to form an effectively inseparable block, for instance by gluing with an adhesive, soldering, brazing or riveting. Then pole rod contours facing are cut toward the axis by wire erosion. The cutting by wire erosion is preferably done for all the pole rods in a single pass, possibly after a preliminary “roughing pass”.

A method for manufacturing a multipole rod system thus may comprise providing insulating rings or tubes with mating faces for the pole rods, and providing one or more metal parts from which the multipole pole rods can be cut, having mating faces that match the mating faces of the insulating rings or tubes. The metal parts are bonded with the insulating rings or tubes to form a rigid unit, and then contours of the pole rods are cut by wire erosion.

It is possible, for instance, to braze individual metal rods to glass-ceramic rings having inward-facing metalized mating faces, forming a kind of cage. The internal contour of the pole rods is then cut by wire erosion from the metal rods of this cage.

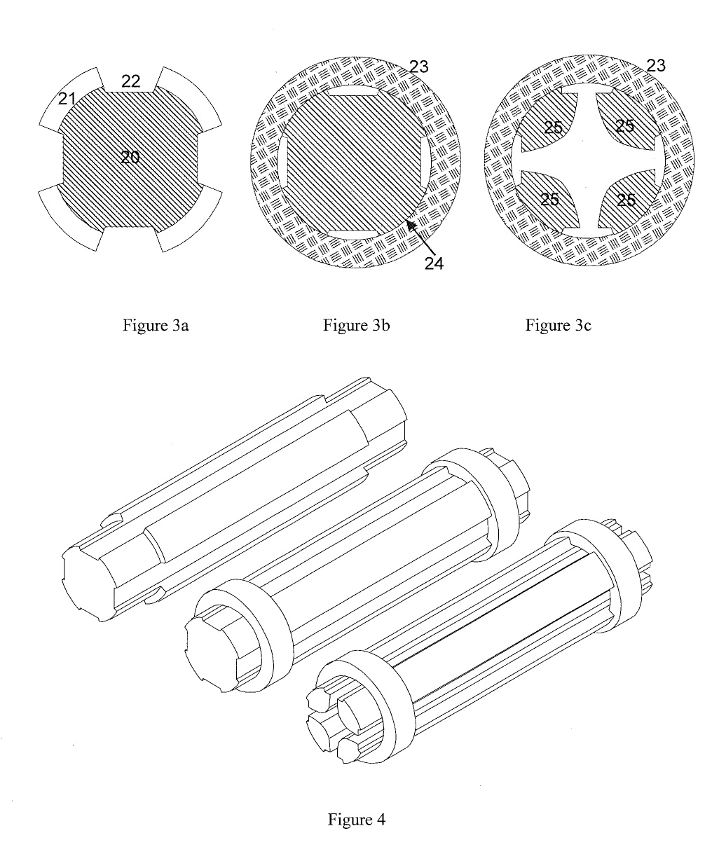

It is, however, also possible, as is shown in FIGS. 3a to 3c, to rigidly bond a single metal block 20 with precise external dimensions in the insulating rings 23 at the mating faces 24 before the inner faces of the pole rods 24 are cut by wire erosion parallel to each other. In this case it is advantageous to provide the metal body 20 with longitudinal grooves 22 so that the wire for the wire erosion can be threaded in.

Instead of two or more insulating rings, a long insulating glass or ceramic tube may be used, enveloping the rod system. Such multipole systems with closed tubes may be used within high vacuum conditions, but can favorably be used, if a gas pressure must be maintained inside the multipole rod system. Such systems enclosed by ceramic or glass tubes may be used with suitable collision gases as collisional fragmentation cells (CID=collisionally induced decomposition), as ion guides with collisional focusing, as quadrupole filter systems, or as ion reaction cells, for instance reactions for ion fragmentation by electron transfer from suitable negative ions (ETD=electron transfer dissociation). The transport of ions through the multipole rod system may then be performed by a controlled gas flow through the tube.

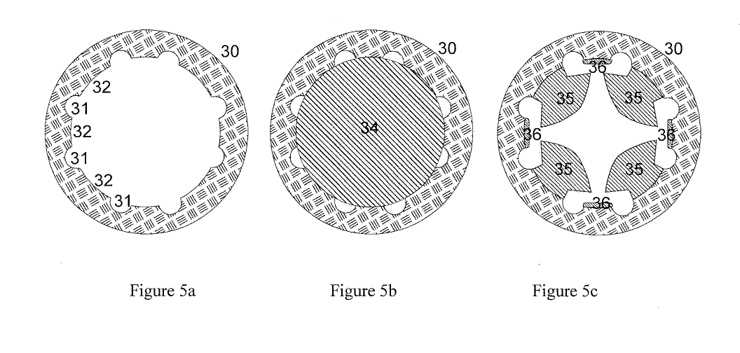

In a somewhat different embodiment of the multipole rod system, the grooves are cut or ground into the insulating rings or tubes instead of into the metal piece. The manufacture of this somewhat different type of quadrupole rod system is illustrated in FIGS. 5a, 5b and 5c. FIG. 5a illustrates an insulating ring 30, which is preferably manufactured from MACOR® machinable ceramic glass, with grooves 31 cut on the inside. The grooves 31 separate the mating faces 32 for the connection with the metal part from one another. FIG. 5b shows how a simple round metal cylinder 33 is glued into the insulating ring, for instance using two-component adhesive suitable for ultra high vacuum conditions. In FIG. 5c the finished quadrupole rod system that has been cut from the metal cylinder can be seen. In addition to the pole rods 35, this quadrupole rod system also includes screening shields 36, whose purpose is to screen out interfering external potentials and to define positively the potential between the pole rods. This avoids charging of the insulating rings by ions that can escape to the outside from between the pole rods.

It is, in principle, also possible to connect the insulating rings to the metal parts by screws, but this variant is not preferred because it can become loose, and creates adjustment problems for subsequent assembly. It is, however, possible to utilize a combination of screws and adhesive. When using screws it is necessary to ensure that no hollow spaces are created that would be difficult or impossible to evacuate. The problem of such voids can, however, be solved in a known manner through the use of hollow screws.

The use of two relatively broad and rigid insulating rings, attached close to the ends of the pole rods, creates an inherently stable arrangement that cannot be twisted or otherwise de-adjusted. In addition, the arrangement is not susceptible to microphony. The widely separated insulating rings also make accurate installation in enclosing systems possible. For instance, when installed in a surrounding mounting tube, de-adjustment of the axial alignment by tilting is largely avoided. The use of a single metal block also ensures that the ends of the pole rods are accurately flush. It is also possible to employ more than two insulating rings. Furthermore, the rings or tubes may have an arbitrary outer contour, for instance a quadratic or polygonal contour, with plane surfaces which can easily be fastened to plane surfaces of holding structures.

By appropriate selection of the coefficients of expansion for the materials of the insulating rings and metal pole rods, it is even possible to ensure that the rod distance (the shortest distance between two opposing pole rods) remains relatively constant when temperatures vary. If, for instance, the insulating rings and the pole rods have coefficients of linear expansion of 8×10⁻⁶ K⁻¹ (porcelain-like ceramic) and 16×10⁻⁶ K⁻¹ (stainless steel) respectively, and if the rod distance is half the magnitude of the diameter of the base circle for the mating faces of the insulating rings, then the condition for a constant pole rod distance under variable temperatures is satisfied. This geometrical relationship is approximately maintained in FIG. 3c. The mating faces where the insulating rings and the metal parts come into contact should then be kept narrow so that stresses along the mating faces arising from temperature changes remain relatively small. Such constancy of the pole rod distance in response to temperature changes is important for mass filters.

Because this insensitivity to temperature variation is not required for many other applications, it may be more advantageous to match the coefficients of linear expansion of the insulating rings and of the pole rods to one another. Temperature changes then do not give rise to stresses at the jointing locations. There are ceramics and metals with a wide variety of expansion coefficients from which the right pair of materials may be chosen.

The electrical connections between the pole rods that are joined to the same phase of the RF voltage can easily be made before the wire erosion is carried out, for instance by spot welding or brazing on appropriately shaped metal strips. It is also possible to provide threaded holes or sockets into which suitable contact screws or plugs can be inserted later. Two metal strips for the two RF phases can also carry sockets to provide contacts for the pole rods.

In precision mechanics, mechanical stresses in the workpiece are problematic whenever it is necessary to manufacture precise parts, since they can lead to spontaneous deformation of the workpiece in the course of further machining processes when these mechanical stresses are partially relieved. Mechanical stresses are created by forging, rolling, turning, milling, grinding, drilling, and also by spot welding or brazing. Some of the distortion stress in the metal parts can be annealed out by heat treatment before bonding to the insulating rings. But residual distortion stresses always remain, or can be newly created by the process of bonding to the insulating rings. Release of the distortion stresses, accompanied by changes in the shape of the workpiece, can in particular also occur during wire erosion as a result of changes in the mechanical stress relationships within the workpiece. It is therefore advantageous to carry out the wire erosion in two steps: a first, coarse roughing pass, in which the stresses can be dispersed, followed by a precision pass that creates the precise contours.

Wire erosion, which takes place in de-ionized water without mechanical or thermal stress, does not introduce any additional stresses, in sharp contrast to machining by turning, milling, drilling or grinding.

Wire erosion, which is a special kind of spark erosion, has now been developed into a high precision method. It can be used to fabricate extremely precise and smooth surfaces, particularly when these surfaces are parallel. Wire erosion takes place in de-ionized water that is kept in motion in order to continuously flush away the eroded particles. The wire is moved longitudinally under precise control. The clamped workpiece is moved under digital control in such a way that it follows the desired contours. Generally speaking, the dimensional accuracy of wire erosion is better than three micrometers, although the parallelism of the faces to one another is more precise than this. The roughness of the surfaces is between about 0.05 and 0.5 micrometers. The inner surfaces of the multipole electrodes facing the axis can be given cylindrical, hyperbolic or indeed any other faun through appropriate programming of the erosion machine.

Since wire erosion machines are also available as four- or five-axis machines, conical shapes can also be cut. “Conical” refers here either to the fact that all the surface lines intersect the axis of symmetry at a point outside the workpiece, or that the pole rods, although they have the same diameter everywhere, are arranged conically with respect to one another. It is therefore also possible to create multipole rod systems that open out conically toward one end. Multipole rod systems of this sort give the ions a slight push in the direction of the wider aperture.

Any metal or any metal alloy can be used as the material for the multipole pieces with the longitudinal electrodes. The metal parts can thus be made from aluminum, stainless steel, brass or many other materials. The use of a hard aluminum alloy is particularly economical, since the speed of erosion is then particularly high. After the multipole pieces have been fabricated, the aluminum alloy can be electrolytically nickel-plated to avoid oxidation of the aluminum; such oxidation would later permit surface charges to develop as a result of ion impacts.

The insulating rings can be made of glass, glass-ceramic (e.g., MACOR® machinable glass ceramic available from Corning), ceramic or even plastic. Low-shrinkage components can be made from plastics with mineral fillers. If aluminum is used for the multipole pieces, then the material for the insulating ring 13 can, for example, be mica-filled PTFE (polytetrafluoroethylene), as this permits an identical coefficient of thermal expansion of 23×10⁻⁶ K⁻¹ to be obtained.

Ceramic or glass-ceramic material is to be preferred for multipole rod systems that must be made to high precision. MACOR® glass ceramic is particularly advantageous for this purpose because it is a machinable. Insulating rings can thus be made from MACOR® machinable glass ceramic in any well-equipped workshop. The mating faces of the MACOR® machinable glass ceramic mounting rings can be given a thin metal coating; they can then be soldered or brazed. The thermal expansions must, however, be considered in order to solder a metal workpiece into a ring of MACOR® machinable glass ceramic. Generally speaking, metals, e.g., aluminum or stainless steel, often have a higher rate of thermal expansion than ceramic materials. Rather than soldering a single-piece metal block into the mounting ring, it is therefore helpful first to divide the metal workpiece longitudinally a number of times so that the gaps can open when it cools down. In order to keep the parts of the workpiece together during the soldering or brazing process it is possible, for instance, to fix them with sliding pins; the pins should be located outside of the finished pole rods.

Using this manufacturing process, hexapole or octopole ion guide systems may be created with rod distances of just a few millimeters. Larger quadrupole rod systems may also be created that can be used as analytic mass filters for ion selection, as collision cells for ion fragmentation, or as “cooling systems” for the cooling collision focusing of ions.

The quadrupole rod systems that can be economically manufactured and yet with high quality by this production method are particularly interesting for use as collision cells for collision-induced ion fragmentation. In the gas-filled collision cells, it is possible, at pressures of between about 10⁻² and 10⁺² pascal, for the ions to be fragmented if, for instance, they are injected at energies of between about 30 and 100 electron-volts, and absorb enough energy from a large number of collisions to undergo ergodic decomposition. In the course of this process they are damped as they move through the collision gas, finally collecting along the longitudinal axis of the quadrupole system, since the system possesses a parabolic pseudopotential that pushes the ions back toward the axis.

In order to move the fragment ions out of the collision cell again particularly efficiently, it is expedient to generate a slight DC voltage drop along the axis of the quadrupole system (e.g., in the order of a few volts) to guide the ions to the output of the system. In order to make a quadrupole rod system that permits the imposition of this kind of DC voltage drop, it is possible to use a rod system made of aluminum and electrolytically oxidized so that an insulating layer is created on all surfaces. The hyperbolic surfaces facing the axis, including the end surfaces, are then coated with a resistance layer, along which a small potential drop can be generated by a suitable voltage. For example see U.S. Pat. No. 7,164,125 to J. Franzen, which is hereby incorporated by reference.

In a different mode of operation, the resistance layer can be used to generate a dipole excitation voltage between the two electrodes 11. This dipole excitation can also be used to fragment the ions.

The ions can, on the other hand, be given their forward drive by a conical multipole rod system. It is not, however, possible to switch this forward drive off electrically. Furthermore, the ions can be transported through the multipole rod system by a controlled gas stream, favorably in a closed multipole rod system enclosed by a tube.

Various types of multipole rod system for different purposes can be economically manufactured using wire erosion with high quality, the advantage being that precision assembly of single pole rods or blocks of pole rods is not needed. Multipole rod systems manufactured according to the invention may be used in mass spectrometers subject to vibration. The multipole systems are operated with RF voltages and can be used in different ways for ion guides, analytical ion selection, collision-induced fragmentation, ion reaction, and collision focusing. The multipole systems can in turn be used as the basis for the construction of systems which can, in addition, deliver a DC potential drop along the axis or dipole excitation voltages transverse to the system.

With knowledge of the invention, those skilled in the art can develop further applications of the method according to the invention.

Although the present invention has been illustrated and described with respect to several preferred embodiments thereof, various changes, omissions and additions to the form and detail thereof, may be made therein, without departing from the spirit and scope of the invention.

What is claimed is:

1. A method for manufacturing a multipole rod system, comprising:
providing insulating rings or tubes with mating faces for pole rods,
providing one or more metal parts, oversized with respect to the final shape of the pole rods, and matching the mating faces of the insulating rings or tubes,
bonding the metal parts with the insulating rings or tubes to form a rigid unit, and
cutting the contour of the pole rods by wire erosion.

2. A method according to claim 1, wherein the step of providing insulating rings or tubes includes providing insulating rings or tubes selected from the group consisting of glass, glass-ceramic, ceramic, plastic or metal with insulating layers.

3. A method according to claim 1, wherein the step of bonding the insulating rings or tubes and the metal parts includes bonding by gluing, soldering, brazing or riveting.

4. A method according to claim 3, wherein the step of bonding the insulating rings or tubes with the metal parts by soldering or brazing, is performed after metalizing the mating faces of the insulating rings or tubes.

5. A method according to claim 1, wherein prior to the step of electrically connecting those metal parts that will later form pole rods attached to the same phase of the RF voltage.

6. A method according to claim 1, wherein the step of cutting comprises cutting out the pole rods in such a way that their inside faces take a hyperbolic contour.

7. A method according to claim 1, wherein the step of cutting comprises cutting out the pole rods in such a way that the cross-sections of the contour remain constant along the axis.

8. A method according to claim 7, further comprising selecting the coefficients of expansion of the insulating rings or tubes and of the metal of the pole rods so that, for a given rod distance of the pole rod arrangement and a given inside diameter of the mating faces of the insulating rings, the rod distance of the final multipole rod system remains constant as the temperature varies.

9. A method according to claim 1, cutting out the pole rods in such a way that the cross-sections of the contour change conically along the axis.

10. A method for manufacturing a multipole rod system, comprising:
providing insulating rings or tubes with mating faces for pole rods;
providing one or more metal parts, oversized with respect to the final shape of the pole rods, and matching the mating faces of the insulating rings or tubes;
bonding the metal parts with the insulating rings or tubes to form a rigid unit; and
wire erosion cutting the metal parts to form the contour of the pole rods.
